(19) United States
(12) Patent Application Publication
(10) Pub. No.: US 2017/0257667 A1
(43) Pub. Date: Sep. 7, 2017

(54) WIRELESS-CAPABLE REMOTE ANTENNA BOXES AND RELATED SYSTEMS AND METHODS

(71) Applicant: Antennas Direct, Inc., Ellisville, MO (US)

(72) Inventors: Richard E. Schneider, Wildwood, MO (US); Joanne Nosiglia, Eureka, MO (US); Christine Hand, St. Louis, MO (US); Nicholas O'Connor, O'Fallon, MO (US); John Edwin Ross, III, Moab, UT (US); Michael Sizemore, Lenexa, KS (US); Griffin Adams, Shawnee, KS (US); Chris Justice, Leawood, KS (US); Craig McDermott, Cedar Rapids, IA (US)

(21) Appl. No.: 15/058,705

(22) Filed: Mar. 2, 2016

(51) Int. Cl. H04N 21/4363; H04N 21/41

(52) U.S. Cl. CPC H04N 21/43637; H04N 21/4122

(57) ABSTRACT

Disclosed are exemplary embodiments of audiovisual systems and related methods. In an exemplary embodiment, an audiovisual system generally includes an antenna box configured for wired connection with an over-the-air (OTA) antenna. The antenna box is operable to process OTA signals received from the OTA antenna and to wirelessly transmit the processed signals, via one or more wireless-capable devices remote from the antenna box, for play as audiovisual content on one or more display devices remote from the antenna box.

### FIELD

The present disclosure generally relates to wireless-capable remote antenna boxes and related systems and methods.

### BACKGROUND

This section provides background information related to the present disclosure which is not necessarily prior art.

Numerous entertainment options, including but not limited to television, cable and Internet-based systems and devices, are currently available for providing a wide range of home entertainment capabilities. One such option, broadcast television, has undergone improvement through conversion to digital broadcasts. Viewers who have installed over-the air (OTA) antennas can obtain free access to broadcast digital content.

### SUMMARY

This section provides a general summary of the disclosure, and is not a comprehensive disclosure of its full scope or all of its features.

According to various aspects, exemplary embodiments are disclosed of audiovisual systems and related methods. In an exemplary embodiment, an audiovisual system generally includes an antenna box configured for wired connection with an over-the-air (OTA) antenna. The antenna box is operable to process OTA signals received from the OTA antenna and to wirelessly transmit the processed signals, via one or more wireless-capable devices remote from the antenna box, for play as audiovisual content on one or more display devices remote from the antenna box.

In another exemplary embodiment, an audiovisual system includes an outdoor over-the-air (OTA) antenna, and an antenna box configured for wired connection with the OTA antenna and for installation remote from one or more display devices. The system also includes one or more wireless-capable devices remote from the antenna box and operable to wirelessly receive broadcast signals received by the OTA antenna and processed by the antenna box for play as audiovisual content on the one or more display devices.

Also disclosed are methods of providing digital content. In an exemplary embodiment, a system-performed method of providing over-the-air (OTA) broadcast content generally includes an outdoor OTA antenna receiving and transmitting broadcast content over a wired connection to an antenna box. The antenna box demodulates, encodes, and wirelessly transmits the content to one or more wireless-capable devices remote from the antenna box. The wireless-capable device(s) transmit the content to one or more display devices remote from the antenna box.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1 through 4 are diagrams of example audiovisual systems including wireless-capable remote antenna boxes in accordance with various embodiments of the disclosure.

Corresponding reference numerals indicate corresponding parts throughout the several views of the drawings.

### DETAILED DESCRIPTION

Example embodiments will now be described more fully with reference to the accompanying drawings.

The inventors hereof have recognized that television viewers wish to have access to a wide range of audiovisual content, not only on their television sets but also on their smart phones, tablets, personal computers, etc. The inventors also have observed that although outdoor OTA antennas typically provide better signal reception than indoor antennas, significant signal loss can occur along lengthy cabling between an outdoor antenna and an indoor set-top box in which tuning and decoding are typically performed. Additionally, for many consumers, the routing of a typical coaxial cable from the outdoor OTA antenna through a wall or window to the indoor television set, or from an indoor OTA antenna located in one room to a television set in an adjoining room, can be problematic. Common issues that prevent consumers from routing such cables include the lack of skills, lack of tools, and mechanical complications unique to particular dwellings. In some cases, such as when the consumer lives in a rented or leased home, apartment or condominium, consumers are actually restricted from drilling holes and running cables due to clauses in rental or lease contracts. A solution which removes the necessity of drilling a hole and routing a coaxial cable can thus enable many consumers to use an outdoor OTA antenna and enjoy improved reception of available digital TV broadcasts throughout their home.

Accordingly, the inventors have developed and disclose herein exemplary embodiments of audiovisual systems having wireless-capable remote antenna boxes. In one example embodiment, an audiovisual system includes an example antenna box configured for wired connection with an OTA antenna, e.g., configured for installation near an outdoor over-the-air (OTA) antenna. The antenna box may be installed, e.g., on or under a rooftop on which the OTA antenna is installed. The antenna box is operable to process OTA signals received from the OTA antenna and to wirelessly transmit the processed signals, e.g., via wireless-capable device(s) remote from the antenna box, for play as audiovisual content on one or more display devices, including but not necessarily limited to a high-definition television (HDTV), remote from the antenna box. Such wireless-capable device(s) may include set-top devices such as a dongle and/or set-top box. It should be noted generally that embodiments are possible in which an antenna referred to herein as an “outdoor” antenna is installed indoors, e.g., in an attic or other interior location. Possible outdoor locations for such an antenna include but are not limited to installation on a roof, tower, fascia, a mast in a yard, etc. Embodiments also are possible in which an antenna box is configured for wired connection with an antenna made for indoor use. In some embodiments, an antenna box may wirelessly transmit a signal from an indoor antenna, e.g., to a HDTV in the same room as the antenna or in a different room. Such embodiments may be useful, e.g., where the location of a HDTV would not allow for optimal positioning of the indoor antenna. In some embodiments, an antenna, antenna box, wireless-capable device(s), and set-top box may all be indoors.

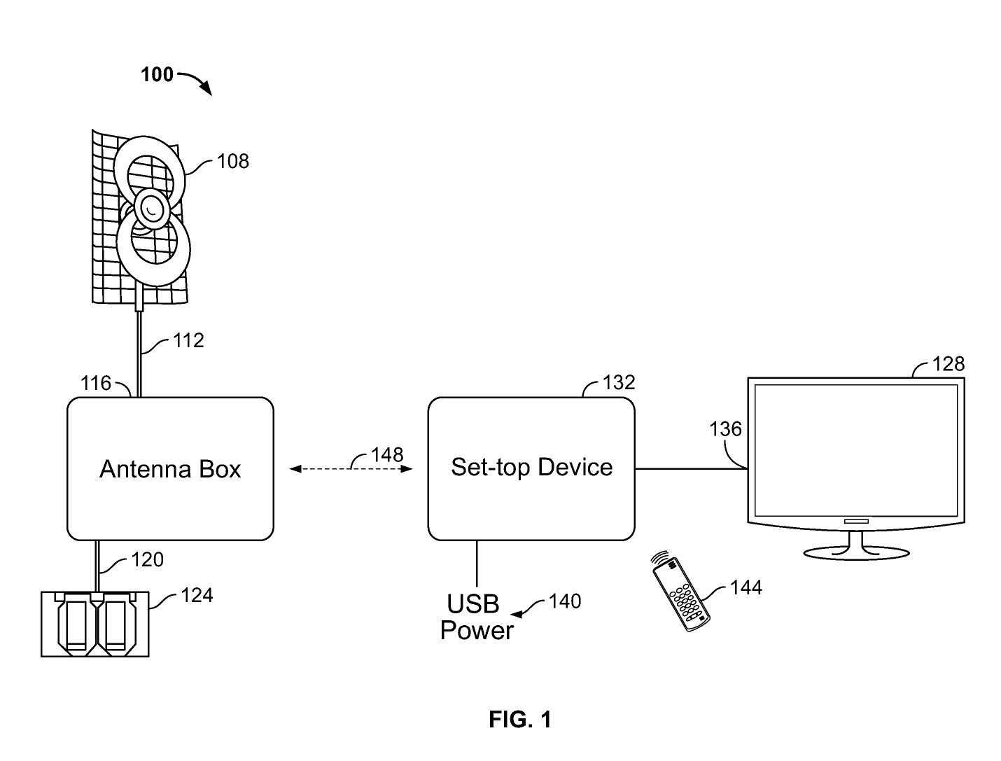

With reference now to the figures, FIG. 1 illustrates an example audiovisual (AV) system 100 embodying one or more aspects of the present disclosure. In various embodiments, the AV system 100 may be provided at a home, office, other structure, etc. In the present example embodiment, the AV system 100 is based at a residence and includes an outdoor over-the-air (OTA) antenna 108 capable of receiving digital media signals. For example, the OTA antenna 108 may receive high-definition television (HDTV) signals that have been multiplexed and broadcast in accordance with ATSC (Advanced Television Systems Committee) standards. The example antenna 108 is available from Antennas Direct of Ellisville, Mo., www.antennasdirect.com. The antenna 108 is an example only, and other or additional outdoor OTA antennas may be used in accordance with various implementations of the present disclosure.

The OTA antenna 108 is, e.g., installed on the roof of the residence and has a wired connection 112 with an antenna box 116. The example antenna box 116 is provided, e.g., on or under the roof, in an attic or at some other location, e.g., near the OTA antenna 108. Embodiments also are possible in which the antenna box 116 is integrated into a housing of the antenna 108. The example antenna box 116 receives power, e.g., through a wired connection 120 to a power supply 124, which may be an outdoor or indoor AC outlet. It is noted that most homes, apartments, and condominiums have at least one outdoor AC outlet that can be used to power an antenna box embodiment. This can eliminate a need for a consumer to drill holes and install AC power cables and outlets and lowers the barrier for consumers wishing to use an outdoor OTA antenna. In the present example embodiment, an antenna box installation location “near the OTA antenna” means a location, e.g., selected so as to minimize the length of the wired connection 112. However, in various embodiments the antenna box 116 may be installed in various indoor or outdoor locations relative to, and at various distances from, the antenna 108. An antenna box installation location may be selected for reasons other than or in addition to minimizing the length of a wired connection to an antenna, such as minimizing the length of AC power cable between the antenna box and the AC outlet.

In the present example embodiment, the antenna box 116 is located remotely from a display device, e.g., a high-definition television (HDTV) 128 located, e.g., in a living room of the residence. The antenna box 116 is operable to process OTA signals received from the OTA antenna 108 and to wirelessly transmit the processed signals, via one or more wireless-capable devices remote from the antenna box 116, e.g., for play on the HDTV 128. The antenna box 116 thus includes, e.g., tuner(s), demodulator(s), a processor, and a wireless communication interface, e.g., a WiFi chip set including a receiver, transmitter, a wireless antenna, and transcoding functionality, e.g., H.264, H.265 and/or other compression technologies.

In various embodiments, the antenna box 116 is configured in a weatherproof enclosure. Additionally or alternatively, the antenna box 116 includes auto-start code for starting antenna box 116 operation when power is applied. In various embodiments, a user is able to use and reconfigure the AV system 100 without being required to interact with the antenna box 116 after the antenna box 116 has been installed. The example antenna box 116 may use multiple tuners/demodulators/processors to provide intelligent channel scanning during setup and/or to acquire information from other channels, where examples of such information may include but are not limited to program guide data, signal strength, etc. Further, the example antenna box 116 may adjust the included transcoding functionality based on information including but not limited to Wi-Fi signal strength, native video resolution, resolution of the display device in use, etc. In various embodiments, the antenna box 116 includes digital video recording (DVR) functionality, including but not limited to pause and/or recording capabilities.

In the present example embodiment, the AV system 100 includes a set-top device, e.g., a dongle 132. Additionally or alternatively, a set-top box could be provided as a set-top device. The dongle 132 is configured for wired and/or plug-in connection with the HDTV 128, e.g., at a HDMI (High-Definition Multimedia Interface) port 136. The dongle 132 includes a processor and a wireless communication interface. In various embodiments, where HDMI Consumer Electronics Control (HDMI-CEC) is enabled on the HDTV 128, a viewer may use one device, e.g., a remote control 144, to control more than one system device. The dongle 132 may receive power, e.g., through a USB (Universal Serial Bus) port 140, which may be provided, e.g., on the HDTV 128 or other power source providing USB access.

In the present example embodiment, the antenna box 116 encodes and wirelessly transmits H.264-encoded video data to the dongle 132 via a protected WiFi channel 148, e.g., using 802.11n WiFi. In some other embodiments, however, other or additional compression technologies and/or wireless protocols could be used. In some embodiments, the remote control 144 and the dongle 132 each include an infrared (IR) communication interface. Additionally or alternatively, the remote control 144 and the dongle 132 each include a radio frequency (RF) communication interface. In various embodiments, the dongle 132 is operable, e.g., by a user using the remote control 144, to download audiovisual content, via the OTA antenna 108 and antenna box 116, from one or more broadcast content sources.

The example AV system 100 makes it possible for a viewer to “plug and play” a HDTV that accepts HDMI input. For example, the viewer can plug in the dongle 132 to connect the antenna 108 and antenna box 116 wirelessly with the HDTV 128 and can then stream broadcast content from the antenna 108 and antenna box 116 for viewing on the HDTV 128. The system 100 also makes it possible for a viewer to “plug and play” a smart TV (i.e., an Internet-capable TV).

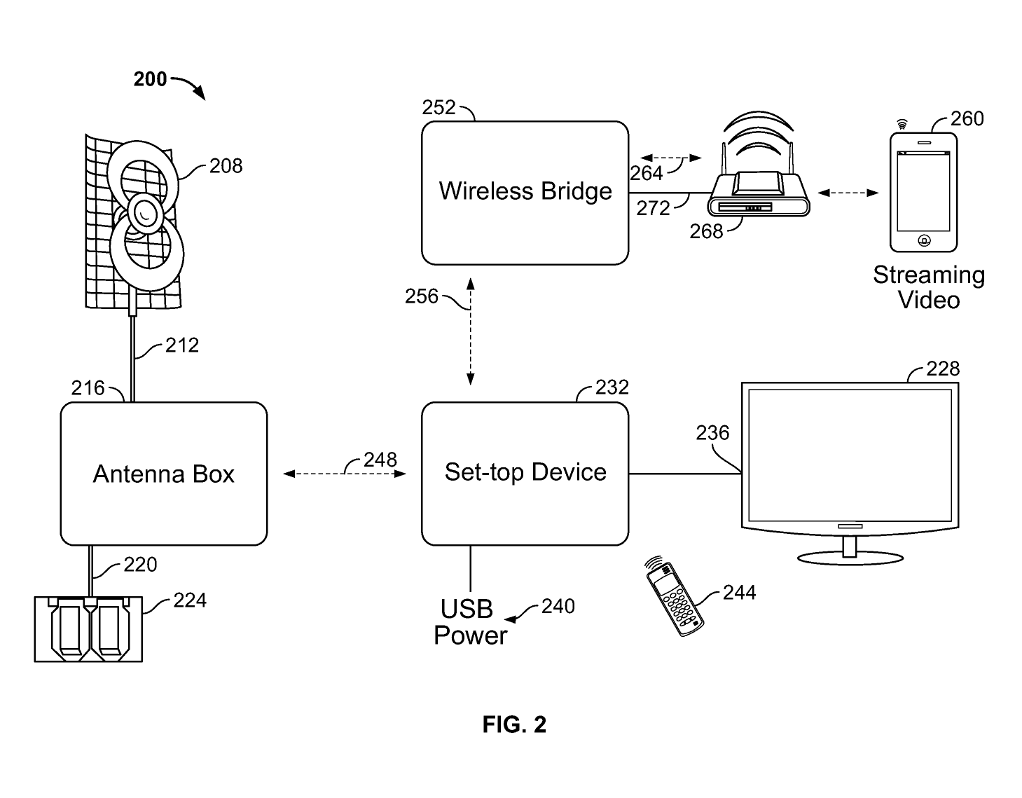

Another example audiovisual (AV) system embodying one or more aspects of the present disclosure is indicated in FIG. 2 by reference number 200. As further described below, the example AV system 200 makes it possible for a viewer to stream broadcast content to more than one display device. The AV system 200 is based, e.g., in a residence and includes an outdoor over-the-air (OTA) antenna 208 capable of receiving digital media signals. For example, the OTA antenna 208 may receive HDTV signals that have been multiplexed and broadcast in accordance with ATSC standards. The OTA antenna 208 is, e.g., installed on the roof of the residence and has a wired connection 212 with an antenna box 216. The antenna box 216 is provided, e.g., on or under the roof, in an attic or at some other location, e.g., near the OTA antenna 208. Embodiments also are possible in which the antenna box 216 is integrated into the antenna 208 housing. The antenna box 216 receives power through a wired connection 220 to a power supply 224, e.g., an outdoor AC outlet.

In the present example embodiment, the antenna box 216 is located remotely from a display device, e.g., a high-definition television (HDTV) 228 located, e.g., in a living room of the residence. The antenna box 216 is operable to process OTA signals received from the OTA antenna 208 and to wirelessly transmit the processed signals, via one or more wireless-capable devices remote from the antenna box 216, e.g., for play on the HDTV 228. The antenna box 216 thus includes, e.g., tuner(s), demodulator(s), a processor, and a wireless communication interface, e.g., a WiFi chip set including a receiver, transmitter, a wireless antenna, and transcoding functionality, e.g., H.264, H.265 and/or other compression technologies. In various embodiments, the antenna box 216 includes digital video recording (DVR) functionality, including but not limited to pause and/or recording capabilities.

In the present example embodiment, the AV system 200 includes a set-top device, e.g., a dongle 232 configured for wired and/or plug-in connection with the HDTV 228, e.g., at a HDMI port 236. The dongle 232 may receive power, e.g., through a USB port 240, which may be provided, e.g., on the HDTV 228 or other power source providing USB access. The dongle 232 includes a processor and a wireless communication interface. Additionally or alternatively, a set-top box could be provided as a set-top device.

In the present example embodiment, the antenna box 216 wirelessly transmits H.264-encoded video to the dongle 232, e.g., over 802.11n WiFi, via a protected WiFi channel 248. In some other embodiments, however, other or additional compression technologies and/or wireless protocols could be used. In the present example embodiment, the set-top dongle 232 is an HDMI-capable device that may be operable, e.g., by a user using a remote control 244, to download audiovisual content to the HDTV 228, via the OTA antenna 208 and antenna box 216, from one or more streaming content sources. Accordingly, in some embodiments, the remote control 244 and the dongle 232 each include an infrared (IR) communication interface. In some other embodiments, the remote control 244 and the dongle 232 each include a radio frequency (RF) communication interface.

Additionally, the set-top dongle 232 may send H.264-encoded broadcast content to a WiFi bridge 252, via a protected WiFi channel 256 using 802.11n WiFi. In some other embodiments, however, other or additional compression technologies and/or wireless protocols could be used. In the present example embodiment, the bridge 252 is configured with two wireless communication interfaces: one interface for wireless communication over the protected channel 256, and the other interface for communication over a WiFi channel 264 in a local network provided in the residence. The bridge 252 is wirelessly accessible in the local wireless network, e.g., by a mobile computing device, e.g., a viewer's smart phone 260, e.g., via an access point/router 268 of the local network. In the present example embodiment, the bridge 252 also includes a wired Ethernet connection 272 with the access point/router 268 that may be used, e.g., instead of the WiFi channel 264. Communication between the access point/router 268 and the smart phone 260 may be, e.g., by 802.11b, 802.11g, 802.11n or 802.11ac. In various embodiments, the smart phone 260 includes transcoding functionality, e.g., H.264, H.265 and/or other compression capability. The smart phone 260 may receive, decode and display broadcast content received from the antenna 208 through the antenna box 216, dongle 232, bridge 252 and access point/router 268.

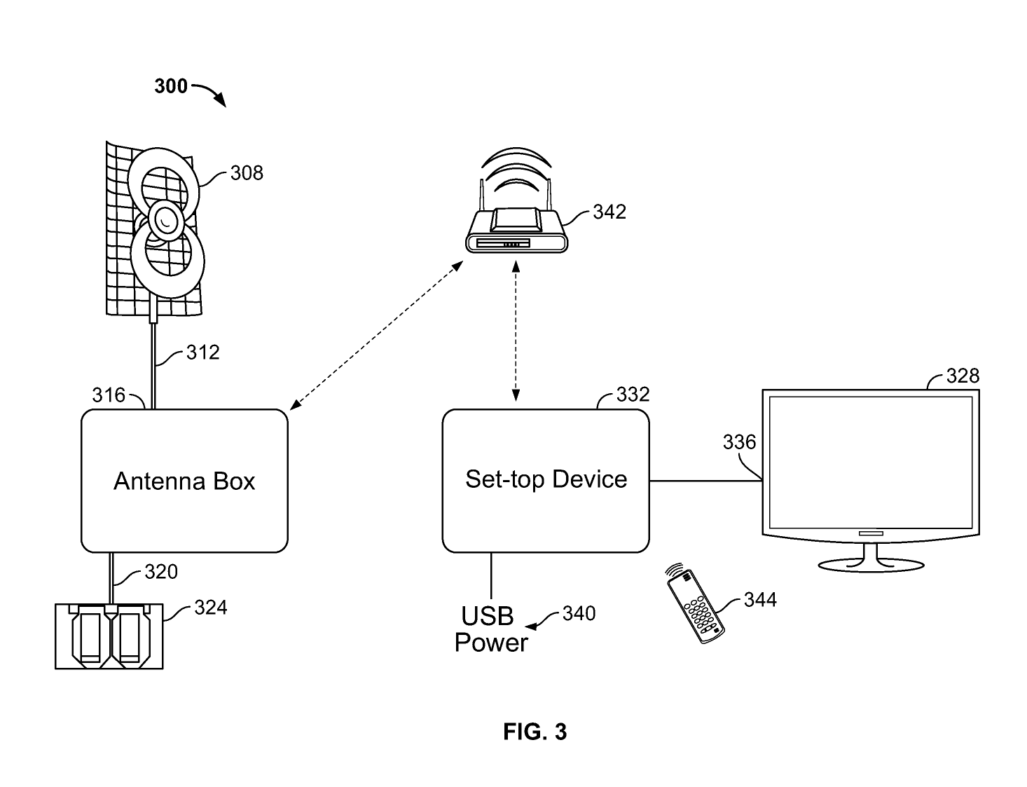

Another example audiovisual (AV) system embodying one or more aspects of the present disclosure is indicated in FIG. 3 by reference number 300. The AV system 300 is based, e.g., in a residence and includes an outdoor over-the-air (OTA) antenna 308 capable of receiving digital media signals. For example, the OTA antenna 308 may receive HDTV signals that have been multiplexed and broadcast in accordance with ATSC standards. The OTA antenna 308 is, e.g., installed on the roof of the residence and has a wired connection 312 with an antenna box 316. The antenna box 316 is provided, e.g., on or under the roof, in an attic or at some other location, e.g., near the OTA antenna 308. Embodiments also are possible in which the antenna box 316 is integrated into the antenna 308 housing. The antenna box 316 receives power through a wired connection 320 to a power supply 324, e.g., an outdoor AC outlet.

In the present example embodiment, the antenna box 316 is located remotely from a display device, e.g., a high-definition television (HDTV) 328 located, e.g., in a living room of the residence. The antenna box 316 is operable to process OTA signals received from the OTA antenna 308 and to wirelessly transmit the processed signals, via one or more wireless-capable devices remote from the antenna box 316, e.g., for play on the HDTV 328. The antenna box 316 thus includes, e.g., tuner(s), demodulator(s), a processor, and a wireless communication interface, e.g., a WiFi chip set including a receiver, transmitter, a wireless antenna, and transcoding functionality, e.g., H.264, H.265 and/or other compression technologies. In various embodiments, the antenna box 316 includes digital video recording (DVR) functionality, including but not limited to pause and/or recording capabilities.

The example AV system 300 includes a set-top device, e.g., a dongle 332 configured for wired and/or plug-in connection with the HDTV 328, e.g., at a HDMI port 336. Additionally or alternatively, a set-top box may be provided as a set-top device. The dongle 332 may receive power, e.g., through a USB port 340, which may be provided, e.g., on the HDTV 328 or other power source providing USB access. The dongle 332 includes a processor and a wireless communication interface. The AV system 300 also includes an access point/router 342, e.g., of a local wireless network provided in the residence. The dongle 332 is configured as a node in the local wireless network.

In the present example embodiment, the antenna box 316 wirelessly transmits H.264-encoded video to the set-top dongle 332 via the access point/router 342, e.g., over 802.11n WiFi. However, other or additional transcoding functionality and/or wireless protocols could be used. The example set-top dongle 332 is an HDMI-capable device that may be operable, e.g., by a user using a remote control 344, to download audiovisual content to the HDTV 328, via the OTA antenna 308, antenna box 316 and access point/router 342, from one or more streaming content sources. Accordingly, in some embodiments, the remote control 344 and the dongle 332 each include an infrared (IR) communication interface. In some other embodiments, the remote control 344 and the dongle 332 each include a radio frequency (RF) communication interface.

Where the HDTV 328 accepts HDMI input and the dongle 332 is included as a node in a viewer's local network, the viewer can stream broadcast content from the antenna 308 and antenna box 316 for viewing on the HDTV 328. Additionally or alternatively, in some embodiments, the system 300 makes it possible for a viewer to stream broadcast content to a smart TV on which a software application provided by the TV manufacturer has been installed that allows the user to play multimedia content from peripheral devices.

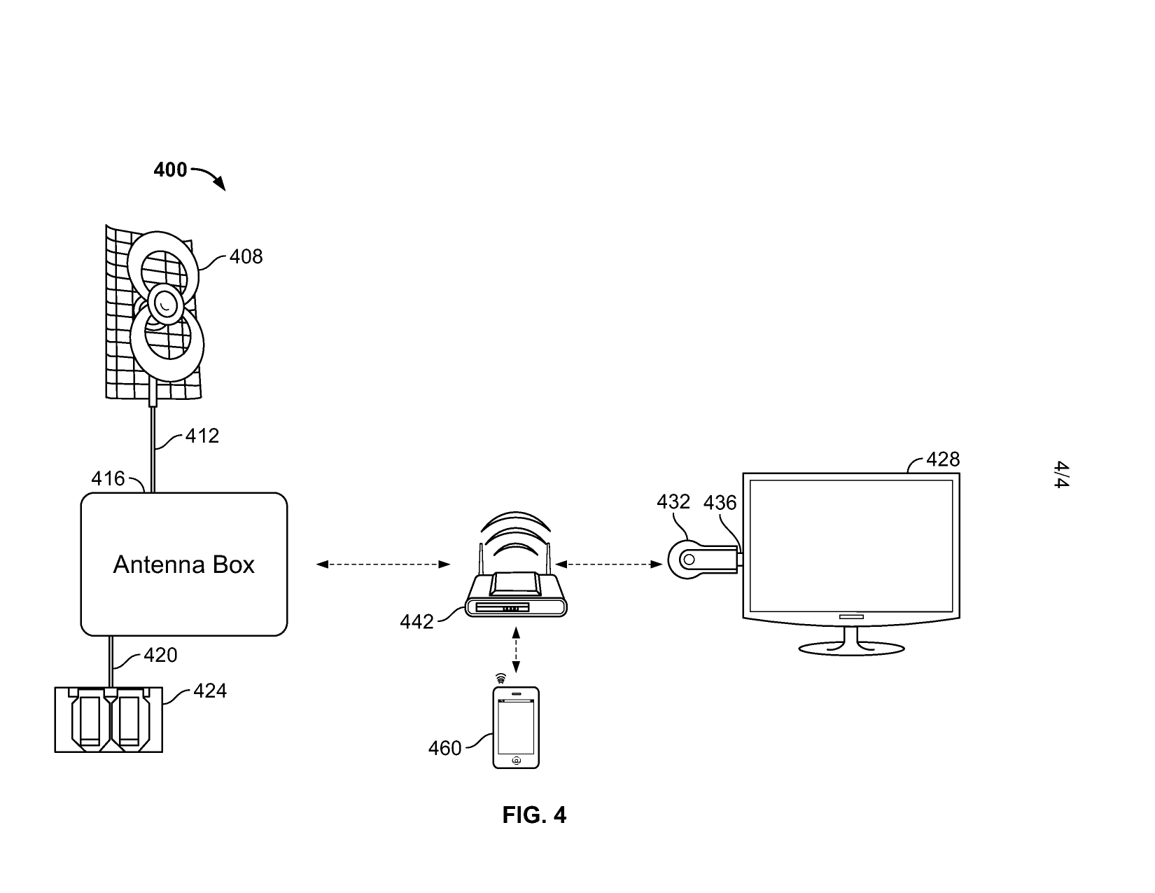

Another example audiovisual (AV) system embodying one or more aspects of the present disclosure is indicated in FIG. 4 by reference number 400. The AV system 400 makes it possible for a viewer to use a third-party dongle or set-top box to stream broadcast content. The AV system 400 is based, e.g., in a residence and includes an outdoor over-the-air (OTA) antenna 408 capable of receiving digital media signals, e.g., HDTV signals that have been multiplexed and broadcast in accordance with ATSC standards. The OTA antenna 408 is, e.g., installed on the roof of the residence and has a wired connection 412 with an antenna box 416. The antenna box 416 is provided, e.g., on or under the roof, in an attic or at some other location, e.g., near the OTA antenna 408. Embodiments also are possible in which the antenna box 416 is integrated into the antenna 408 housing. The antenna box 416 receives power through a wired connection 420 to a power supply 424, e.g., an outdoor AC outlet.

In the present example embodiment, the antenna box 416 is located remotely from a display device, e.g., a high-definition television (HDTV) 428 located, e.g., in a living room of the residence. The antenna box 416 is operable to process OTA signals received from the OTA antenna 408 and to wirelessly transmit the processed signals, via one or more wireless-capable devices remote from the antenna box 416, e.g., for play on the HDTV 428. The antenna box 416 thus includes, e.g., tuner(s), demodulator(s), a processor, and a wireless communication interface, e.g., a WiFi chip set including a receiver, transmitter, a wireless antenna, and transcoding functionality, e.g., H.264, H.265 and/or other compression technologies. In various embodiments, the antenna box 416 includes digital video recording (DVR) functionality, including but not limited to pause and/or recording capabilities.

The example AV system 400 includes a set-top device, e.g., a dongle 432 configured for wired and/or plug-in connection with the HDTV 428, e.g., at a HDMI port 436. The dongle 432 is provided, e.g., by a content-streaming company such as Google®, Amazon®, Apple®, etc., and includes a processor and a wireless communication interface. In various embodiments, a set-top box may be provided additionally or alternatively as a set-top device. The AV system 400 also includes an access point/router 442, e.g., of a local wireless network provided in the residence. The example dongle 432 is configured as a wireless node in the local wireless network.

In the present example embodiment, the antenna box 416 wirelessly transmits H.264-encoded video to the set-top dongle 432 via the access point/router 442, e.g., over 802.11n WiFi. In some other embodiments, however, other or additional transcoding functionality and/or wireless protocols could be used. The example set-top dongle 432 is an HDMI-capable device that may be operable, e.g., by a user using a mobile computing device such as a smart phone 460, to download audiovisual content to the HDTV 428 and/or to the smart phone 460, via the OTA antenna 408, antenna box 416 and access point/router 442, from one or more streaming content sources. Depending on the type of dongle 432, a user may download a software application to the smart phone 460 in order to use the smart phone 460 as a remote control for sending broadcast content to the HDTV 428 and/or smart phone 460. The example dongle 432 may, e.g., stream and/or decode the received content.

The foregoing embodiments make it possible for a viewer to receive, from a wide range of content sources, broadcast content having high signal quality. A cabling run from an antenna to the antenna box can be short, due to the close proximity of the box to the antenna. Because an antenna box often can be located near the antenna and apart from a living room or other viewing area, it can be possible to eliminate a set-top box from the living room or other viewing area.

Various antenna box embodiments having weatherproof enclosures can be installed outdoors or in other exposed locations. Additionally or alternatively, embodiments of the foregoing antenna box are self-starting when power is applied. In various embodiments, a user is able to use and reconfigure his/her AV system without having to access the antenna box after the antenna box has been installed. Example antenna box embodiments can provide intelligent channel scanning during setup and can acquire information such as program guide data, signal strength, etc., from other channels. Further, various antenna box embodiments can adjust their transcoding functionality based on information such as Wi-Fi signal strength, native video resolution, resolution of the display device in use, etc. In various embodiments, an antenna box can provide digital video recording (DVR) functionality, including but not limited to pause and/or recording capabilities.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10,or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An audiovisual system comprising:
an antenna box configured for wired connection with an over-the-air (OTA) antenna, the antenna box having one or more processors, one or more tuners, one or more demodulators, and a wireless communication interface;
wherein the antenna box is operable to transcode OTA signals received from the OTA antenna and to wirelessly transmit the transcoded signals, via one or more wireless-capable devices remote from the antenna box, for play as audiovisual content on one or more display devices remote from the antenna box;
the antenna box further configured to adjust the transcoding based on a signal strength of wireless communication between the antenna box and the one or more wireless-capable devices.

2. The audiovisual system of claim 1, wherein the one or more display devices include a high-definition television (HDTV) set, and the one or more wireless-capable devices include a dongle configured for wired and/or plug-in connection with the HDTV set.

3. The audiovisual system of claim 2, wherein the one or more wireless-capable devices comprise a wireless network bridge having a first wireless communication interface operable for communication with the dongle, and a second wireless communication interface operable for communication with an access point/router of a local wireless network.

4. The audiovisual system of claim 3, wherein the one or more display devices include a mobile computing device configured to receive the audiovisual content wirelessly via the bridge and the access point/router.

5. The audiovisual system of claim 2, further comprising a remote control operable for communication with the dongle using an infrared (IR) communication interface or a radiofrequency (RF) communication interface.

6. The audiovisual system of claim 2, wherein the antenna box is operable to communicate wirelessly with the dongle via an access point/router of a local wireless network.

7. The audiovisual system of claim 6, wherein the dongle is wirelessly accessible by a mobile computing device via the local wireless network.

8. The audiovisual system of claim 2, configured without a set-top box.

9. The audiovisual system of claim 1, wherein the one or more wireless-capable devices include one or more of the following: a dongle, a set-top box, an access point (AP), a router, a wireless network bridge, a personal computer, a tablet, and a smart phone.

10. The audiovisual system of claim 1, further comprising the OTA antenna.

11. An audiovisual system comprising:
an outdoor over-the-air (OTA) antenna;
an antenna box configured for wired connection with the OTA antenna and for installation remote from one or more display devices, the antenna box having one or more processors, one or more tuners, one or more demodulators, a digital video recorder (DVR), and a wireless communication interface; and
one or more wireless-capable devices remote from the antenna box and operable to wirelessly receive broadcast signals received by the OTA antenna and as transcoded and/or recorded by the antenna box for play as audiovisual content on the one or more display devices;
one of the wireless-capable devices being a dongle connected with one of the one or more display devices.

12. The audiovisual system of claim 11, wherein the one or more display devices include a high-definition television (HDTV) set, and the one or more wireless-capable devices include a dongle connectible with the HDTV set.

13. The audiovisual system of claim 12, wherein the dongle is configured to stream the processed signals for display by the one or more display devices.

14. The audiovisual system of claim 13, wherein the dongle is remotely controllable by a mobile computing device.

15. The audiovisual system of claim 12, wherein the one or more wireless-capable devices comprise a wireless network bridge having a first wireless communication interface operable for communication with the dongle, and a second wireless communication interface operable for communication with an access point/router of a local wireless network.

16. The audiovisual system of claim 11, wherein one of the one or more wireless-capable devices is configured to wirelessly receive signals from the antenna box over a protected wireless channel.

17. The audiovisual system of claim 11, configured without a set-top box.

18. A system-performed method of providing over-the-air (OTA) broadcast content, the method comprising:
an OTA antenna receiving and transmitting broadcast content over a wired connection to an antenna box;
the antenna box demodulating, transcoding, and wirelessly transmitting the content to one or more wireless-capable devices remote from the antenna box, the transcoding adjustably performed based on signal strength of the wireless transmitting; and
the one or more wireless-capable devices transmitting the content to one or more display devices remote from the antenna box.

19. The method of claim 18, performed without using a set-top box.

20. The method of claim 19, further comprising the antenna box communicating wirelessly with the one or more wireless-capable devices via an access point/router of a local wireless network.
